(19) United States
(12) Patent Application Publication
(10) Pub. No.: US 2024/0146615 A1
(43) Pub. Date: May 2, 2024

(54) METHOD OF CONSTRUCTING NETWORK IN FACTORY ENERGY MANAGEMENT SYSTEM AND APPARATUS FOR PERFORMING THE SAME

(71) Applicant: ELECTRONICS AND TELECOMMUNICATIONS RESEARCH INSTITUTE, Daejeon (KR)

(72) Inventors: Jin Doo JEONG, Sejong-si (KR); IL Woo LEE, Daejeon (KR)

(21) Appl. No.: 18/378,283

(22) Filed: Oct. 10, 2023

(30) Foreign Application Priority Data
Oct. 26, 2022 (KR) 10-2022-0139089
Sep. 4, 2023 (KR) 10-2023-0116969

(51) Int. Cl. H04L 41/14; H04L 41/0803

(52) U.S. Cl. CPC H04L 41/145; H04L 41/0803; H04L 67/12

(57) ABSTRACT

A method of constructing a factory energy management system (FEMS) network and an apparatus for performing the same are provided. The method includes obtaining a first metric and a second metric based on configuration information of the FEMS network and optimizing distribution of repeaters included in the network based on the first metric and the second metric.

### CROSS-REFERENCE TO RELATED APPLICATIONS

This application claims the benefit of Korean Patent Application No. 10-2022-0139089, filed on Oct. 26, 2022, and Korean Patent Application No. 10-2023-0116969, filed on Sep. 4, 2023, in the Korean Intellectual Property Office, the entire disclosures of which are incorporated herein by reference for all purposes.

### BACKGROUND

### 1. Field of the Invention

One or more embodiments relate to a method of constructing a network in a factory energy management system (FEMS) and an apparatus for performing the same.

### 2. Description of Related Art

Reduction of energy and power consumption in the industrial sector greatly contributes to national energy conservation. A factory energy management system (FEMS) may achieve energy efficiency through energy management in the industrial sector.

In order to construct the FEMS, monitoring for energy consumption of energy resources in factories may be required. In general, wired communication has been mainly used thus far for monitoring and controlling resources/devices in industrial sectors, particularly in factories where there are many non-communication factors such as metal, dust, and vibration. However, with the advent of the fourth industrial revolution, wireless communication technologies such as the fifth-generation (5G) are evolving to be used to construct factory networking for networking establishment cost reduction and process flexibility. This indicates that among the evolving industrial wireless communication technologies, a wireless communication technology suitable for FEMS networking to be established may be selected and applied considering networking establishment factors such as functions and costs.

In order to construct a wireless communication network for an FEMS in a factory having a poor channel environment for wireless communication technology, it may be necessary to minimize a shaded area of a wireless communication signal. Wireless communication may be performed smoothly by minimizing a wireless communication shaded area between communication nodes and a gateway. In general, a wireless communication shaded area between communication nodes and a gateway may be minimized through a configuration of repeaters.

Various channel environments may exist due to factory environmental characteristics depending on products with various processing methods (e.g., continuous process, interrupted process, batch process depending on the product production method) and even within a particular factory, due to characteristics of the factory configuration according to the energy management level (e.g. utility, systems, and processes). Due to diverse channel environments, a repeater configuration method of minimizing a wireless communication shaded area may be difficult to be manualized. When arranged repeaters are more than necessary, the configuration cost of the arranged repeaters may increase. When necessary repeaters are not arranged, the quality of wireless communication in the area may be degraded.

The above description has been possessed or acquired by the inventor(s) in the course of conceiving the present disclosure and is not necessarily an art publicly known before the present application is filed.

### SUMMARY

In order to construct a factory energy management system (FEMS) network in which a wireless communication shaded area is minimized, a technique of arranging an appropriate number of repeaters in an appropriate position is required.

One or more embodiments provide constructing repeaters on an FEMS network based on a conditional probability of an error-free signal transmitted by a communication node and a conditional probability of repeater selection on a communication path.

However, technical goals are not limited to the foregoing goals, and there may be other technical goals.

According to an aspect, there is provided a method of constructing an FEMS network, the method including obtaining a first metric and a second metric based on configuration information of the FEMS network and optimizing distribution of repeaters included in the FEMS network based on the first metric and the second metric, wherein the first metric may be related to whether a signal from a communication node is transmitted normally, wherein the second metric may be related to whether a specific repeater is included in a communication path through which the signal is transmitted.

The FEMS network may provide a wireless communication method having a function of identifying a transmission error of the signal transmitted from the communication node and a function of identifying the communication path of the signal.

The optimizing of the distribution of the repeaters may include detecting a communication shaded area on the FEMS network based on the first metric and adding a repeater to solve the communication shaded area when the communication shaded area is detected.

The detecting of the communication shaded area may include identifying whether the first metric is less than a threshold related to a probability that the signal is transmitted normally and detecting the communication shaded area in response to identifying that the first metric is less than the threshold.

The optimizing of the distribution of the repeaters may include removing an unnecessary repeater from the FEMS network based on the second metric.

The removing of the unnecessary repeater may include identifying whether the second metric is less than a threshold related to a probability that the specific repeater is included in the communication path and removing the unnecessary repeater in response to identifying that the second metric is less than the threshold.

The obtaining of the first metric and the second metric and the optimizing of the distribution of repeaters may be performed for all processes to be managed by the FEMS.

According to an aspect, there is provided an apparatus of constructing an FEMS network, the apparatus including a memory configured to store one or more instructions and a processor configured to execute the instructions, wherein the processor may be configured to perform a plurality of operations when the instructions are executed, wherein the plurality of operations may include obtaining a first metric and a second metric based on configuration information of the FEMS network and optimizing distribution of repeaters included in the FEMS network based on the first metric and the second metric, wherein the first metric may be related to whether a signal from a communication node is transmitted normally, and wherein the second metric may be related to whether a specific repeater is included in a communication path through which the signal is transmitted.

The FEMS network may provide a wireless communication method having a function of identifying a transmission error of the signal transmitted from the communication node and a function of identifying the communication path of the signal.

The optimizing of the distribution of the repeaters may include detecting a communication shaded area on the FEMS network based on the first metric and adding a repeater to solve the communication shaded area when the communication shaded area is detected.

The detecting of the communication shaded area may include identifying whether the first metric is less than a threshold related to a probability that the signal is transmitted normally and detecting the communication shaded area in response to identifying that the first metric is less than the threshold.

The optimizing of the distribution of the repeaters may include removing an unnecessary repeater from the FEMS network based on the second metric.

The removing of the unnecessary repeater may include identifying whether the second metric is less than a threshold related to a probability that the specific repeater is included in the communication path and removing the unnecessary repeater in response to identifying that the second metric is less than the threshold.

The plurality of operations may be performed for all processes to be managed by the FEMS.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of a factory energy management system (FEMS) network construction system according to an embodiment;

FIG. 2 illustrates an example of the FEMS network shown in FIG. 1;

FIG. 3 is a diagram illustrating a first metric and a second metric according to an embodiment;

FIG. 4 is a flowchart illustrating an example of a method of constructing an FEMS network, according to an embodiment;

FIG. 5 is a flowchart illustrating another example of a method of constructing an FEMS network, according to an embodiment; and

FIG. 6 illustrates an example of an apparatus according to an embodiment.

### DETAILED DESCRIPTION

The following detailed structural or functional description is provided as an embodiment only and various alterations and modifications may be made to embodiments. Here, embodiments are not construed as limited to the disclosure and should be understood to to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

Unless otherwise defined, all terms used herein including technical or scientific terms have the same meaning as commonly understood by one of ordinary skill in the art to which embodiments belong. Terms, such as those defined in commonly used dictionaries, should be construed to have meanings matching with contextual meanings in the relevant art and the present disclosure, and are not to be construed as an ideal or excessively formal meaning unless otherwise defined herein.

Hereinafter, embodiments will be described in detail with reference to the accompanying drawings. When describing the embodiments with reference to the accompanying drawings, regardless of drawing numerals, like reference numerals refer to like elements and a repeated description related thereto will be omitted.

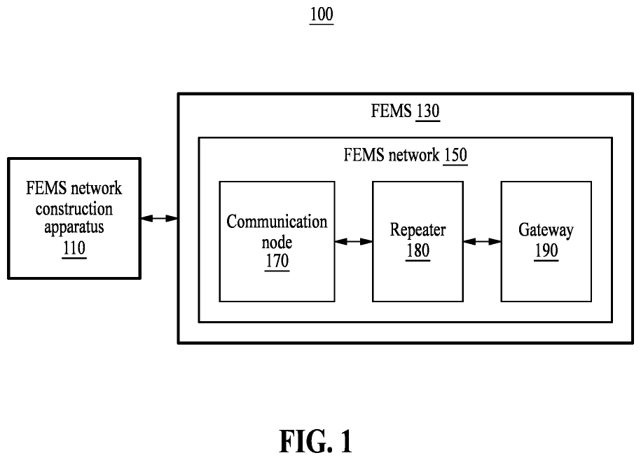

FIG. 1 illustrates an example of a factory energy management system (FEMS) network construction system according to an embodiment.

Referring to FIG. 1, an FEMS network construction system 100 may include an FEMS network construction apparatus 110 and an FEMS 130. The FEMS 130 may include an FEMS network 150. The FEMS network 150 may include a communication node 170, a repeater 180, and a gateway 190. However, FIG. 1 is an example for illustrating the present disclosure, and the scope of the present disclosure should not be construed as limiting the scope of the disclosure. For example, a plurality of communication nodes 170, a plurality of repeaters 180, and a plurality of gateways 190 may be provided. In another example, the FEMS network construction apparatus 110 may be included in the FEMS 130.

The communication node 170 may transmit or receive a signal (e.g., FEMS observation data) to or from an FEMS observation point (e.g., a sensor or an instrument). The communication node 170 may transmit or receive a signal (e.g., FEMS control data) to or from an FEMS control point (e.g., an actuator). The communication node 170 may be a wireless communication terminal that transmits or receives a signal to or from the FEMS observation point and the FEMS control point.

The gateway 190 may communicate with communication node 170. The gateway 190 may receive or transmit a signal (e.g., FEMS observation data and FEMS control data) from or to the communication node 170. The gateway 190 may check whether the signal transmitted from the communication node 170 has an error. For example, the gateway 190 may check whether a signal transmitted from the communication node 170 has a packet error. The gateway 190 may request retransmission of a signal from the communication node 170 through the repeater 180.

The repeater 180 may relay communication between the communication node 170 and the gateway 190. For example, the communication node 170 may transmit a signal to the gateway 190 through a plurality of repeaters 180. However, embodiments are not limited thereto, and the communication node 170 may directly transmit a signal to the gateway 190.

The FEMS network 150 may provide a wireless communication method for communication between the communication node 170, the repeater 180, and the gateway 190. The wireless communication method may have a function of identifying a transmission error of a signal transmitted from the communication node 170 in the gateway 190. For example, the gateway 190 may check whether a signal transmitted from the communication node 170 has a packet error. A function of identifying a packet error may be performed through a frame check sum (FCS) based on a cyclic redundancy check (CRC).

In addition, the wireless communication method may have a function of identifying a communication path of a signal. A communication path may include a path through which a signal is transmitted. For example, a signal transmitted to the gateway 190 may include data about a communication path. The data about the communication path may include an address (or an index) of the communication node 170 that transmits the signal and an address (or an index) of the repeater 180 through which the signal passes. The gateway 190 may identify the communication path that is related to which of the communication node 170 and/or the repeater 180 the signal is transmitted through, based on the data about the communication path.

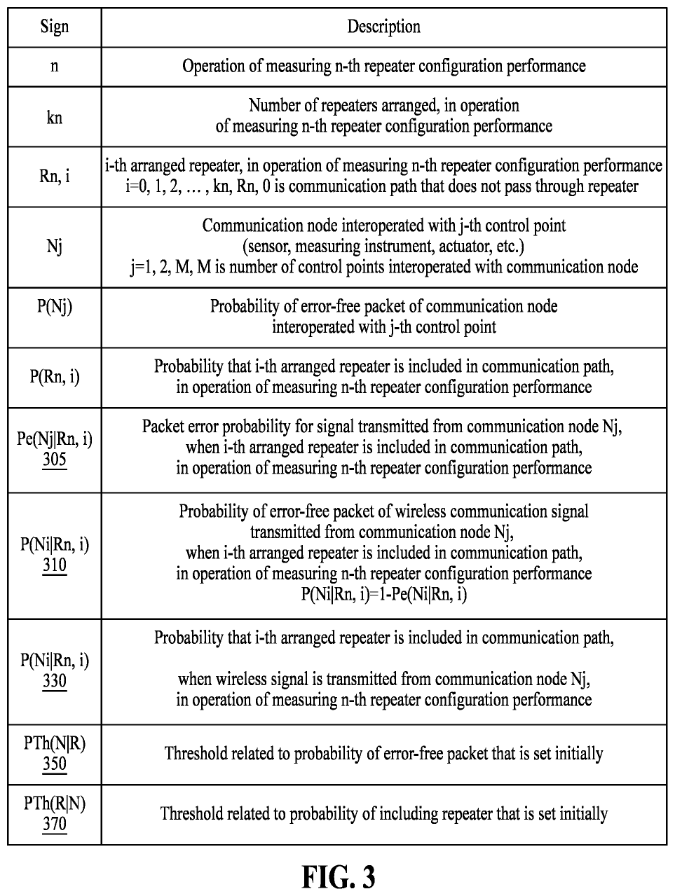

The FEMS network construction apparatus 110 may obtain a first metric (e.g., a first metric 310 of FIG. 3) and a second metric (e.g., a second metric 330 of FIG. 3) based on the configuration of the FEMS network 150. The first metric 310 may relate to whether a signal from the communication node 170 is transmitted normally. The second metric 330 may be related to whether a specific repeater 180 is included in the communication path through which the signal sent by the communication node 170 is transmitted. The first metric 310 and the second metric 330 may be based on a conditional probability.

Before considering the conditional probability to be utilized in the present disclosure, the law of total probability related to the conditional probability may be considered herein. In probability theory, the theory of total probability is a rule for calculating a probability by dividing a sample space into non-overlapping events, wherein the sample space may be expressed with respect to “N” events that are non-overlapping, as in Equation 1 below.

P(A)=Σⱼ₌₁^{N}P(A|Bⱼ)=P(A|B₁)+P(A|B₂)+ . . . +P(A|B_{N}) [Equation 1]

In the probability theory, the conditional probability refers to the probability of an event occurring under the condition that another event has already occurred and may be expressed as Equation 2 below according to Bayes' theorem.

$$P ( {A}_{i} \vert B ) = \frac{P ( B \vert {A}_{i} ) P ( {A}_{i} )}{P ( B )} \qquad [ Equation 2 ]$$

If Equation 1 representing the law of total probability is applied to Equation 2 representing the conditional probability, Equation 2 may be extended to Equation 3 as below.

$$P ( {A}_{i} \vert B ) = \frac{P ( B \vert {A}_{i} ) P ( {A}_{i} )}{P ( B )} = \frac{P ( B \vert {A}_{i} ) P ( {A}_{i} )}{{\sum }_{j = 1}^{N} P ( B \vert {A}_{i} )} = \frac{P ( B \vert {A}_{i} ) P ( {A}_{i} )}{P ( B \vert {A}_{1} ) + P ( B \vert {A}_{2} ) + … + P ( B \vert {A}_{N} )} \qquad [ Equation 3 ]$$

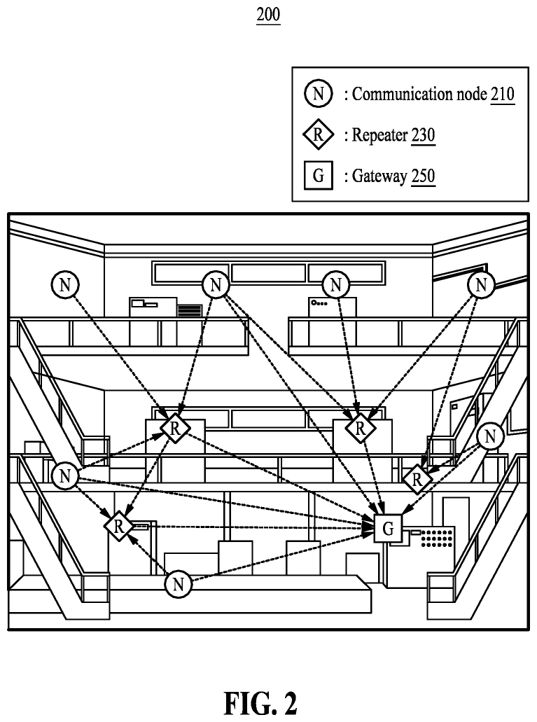

Hereinafter, based on the Equations 1, 2, and 3, the first metric 310 and the second metric 330 for each communication method may be calculated, and a method of constructing an FEMS network is described in detail with reference to FIGS. 2 and 3.

FIG. 2 illustrates an example of the FEMS network 150 shown in FIG. 1, and FIG. 3 is a diagram illustrating a first metric and a second metric according to an embodiment.

Referring to FIGS. 2 and 3, an FEMS network 200 may include a plurality of communication nodes 210, a plurality of repeaters 230, and a plurality of gateways 250. The FEMS network 200 may be the FEMS network 150 of FIG. 1. The communication node 210, the repeater 230, and the gateway 250 may be the communication node 170, the repeater 180, and the gateway 190 of FIG. 1, respectively.

The FEMS network construction apparatus 110 may obtain a first metric (e.g., the first metric 310 in FIG. 3) and a second metric (e.g., the second metric 330 in FIG. 3) based on the configuration of the FEMS network 200. As a result of operating the FEMS network 200 (a network equipped with the wireless communication method of the FEMS network 150 described with reference to FIG. 1) for a predetermined period of time, configuration information of the FEMS network 200 may include results regarding a packet error probability for a signal and a probability that a specific repeater is included in the communication path.

The first metric 310 may be related to whether a signal from the communication node 210 is transmitted normally. For example, the first metric 310 may be related to the probability that a signal packet is normal when an i-th repeater 230 is included in the communication path of the signal transmitted from an Nⱼ-th communication node 210. The FEMS network construction apparatus 110 may obtain the first metric 310 based on the communication path of the signal transmitted from the communication node 210 and whether there is an error. Specifically, the FEMS network construction apparatus 110 may obtain the first metric 310 through Equation 4.

$$[ Equation 4 ]$$

$$P ( {N}_{j} \vert {R}_{n , i} ) = 1 - {P}_{e} ( {N}_{j} \vert {R}_{n , i} ) = 1 - \frac{\begin{matrix} \\ Error packet number among \\ packets including repeater R \text{?} \\ in communication path \\ for predetermined period of time\end{matrix}}{\begin{matrix}Packet number including repeater \\ R \text{?} in communication path \\ predetermined period of time\end{matrix}}$$

$$\text{?} \text{indicates text missing or illegible when filed}$$

Parameters in Equation 4 are as shown in FIG. 3.

The second metric 330 may relate to whether a specific repeater 230 is included in a communication path through which a signal is transmitted. For example, the second metric 330 may relate to the probability that the i-th repeater 230 is included in the communication path of the signal transmitted from the Nⱼ-th communication node 210. Specifically, the FEMS network construction apparatus 110 may obtain the second metric 330 through Equations 5 and 6.

$$P ( {R}_{n , i} \vert {N}_{j} ) = \frac{P ( {N}_{j} \vert {R}_{n , i} ) P ( {R}_{n , i} )}{P ( {N}_{j} )} = \frac{( {N}_{j} \vert {R}_{n , i} ) P ( {R}_{n , i} )}{{\sum }_{j = 1}^{N} P ( {N}_{j} \vert {R}_{n , i} )} = \frac{P ( {N}_{j} \vert {R}_{n , i} ) P ( {R}_{n , i} )}{P ( {N}_{j} \vert {R}_{n , 0} ) + P ( {N}_{j} \vert {R}_{n , 1} ) + … + P ( {N}_{j} \vert {R}_{n , {K}_{n}} )} \qquad [ Equation 5 ]$$

$$[ Equation 6 ]$$

$$P ( {R}_{n , i} ) = \frac{\begin{matrix}Number of times in which signal is relayed \\ through repeater R \text{?} on communication path identified \\ by gateway during predermined period of time\end{matrix}}{\begin{matrix}Number of times in which signal is relayed \\ through repeater on communication path identified \\ by gateway during predetermined period of time\end{matrix}}$$

$$\text{?} \text{indicates text missing or illegible when filed}$$

Parameters in Equations 5 and 6 are as shown in FIG. 3. In Equation 5, Σₖ₌₀^{K}^{ₙ}P(Nⱼ|R_{n,k}) may be obtained through Equation 4.

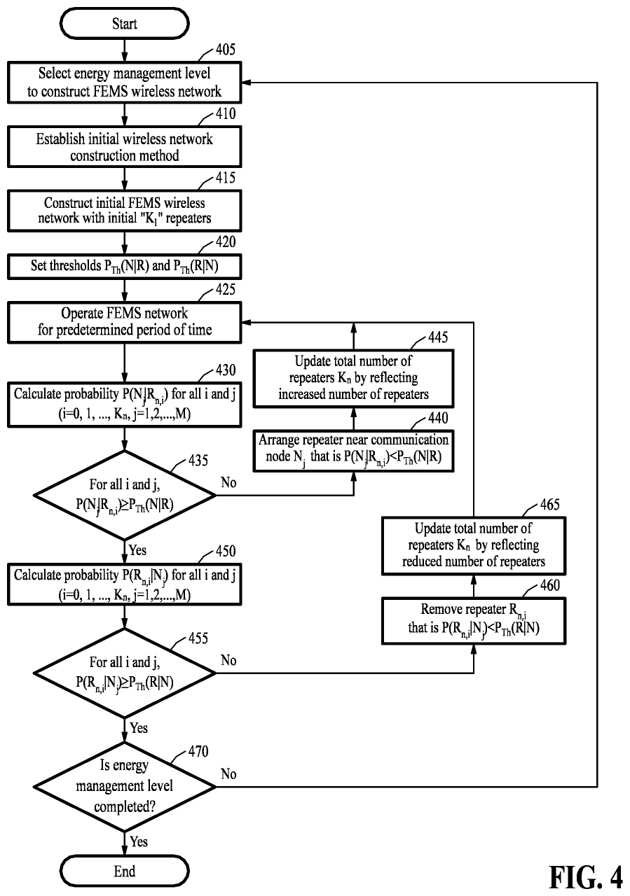

The FEMS network construction apparatus 110 may optimize distribution of repeaters 230 included in the FEMS network 200 based on the first metric 310 and the second metric 330. The FEMS network construction apparatus 110 may detect a communication shaded area on the FEMS network 200 based on the first metric 310. The FEMS network construction apparatus 110 may remove an unnecessary repeater 230 on the FEMS network based on the second metric 330. This is described in detail with reference to FIG. 4.

FIG. 4 is a flowchart illustrating an example of a method of constructing an FEMS network, according to an embodiment.

Referring to FIG. 4, in operation 405, the FEMS network construction apparatus 110 may select a process (e.g., an energy management level) for constructing an FEMS network. The process may be managed by an FEMS. For example, the process may include a utility process, a system process, and a step process.

In operation 410, the FEMS network construction apparatus 110 may establish an initial construction method of the FEMS network. In operation 415, the FEMS network construction apparatus 110 may construct an initial FEMS network based on the initial construction method. For example, the FEMS network construction apparatus 110 may construct the FEMS network using “K₁” repeaters 180.

In operation 420, the FEMS network construction apparatus 110 may set a threshold (e.g., thresholds 350 and 370 of FIG. 3). The threshold 350 may include a threshold associated with a probability that a signal is transmitted normally. The threshold 370 may set a threshold for a probability that a specific repeater 230 is included in a communication path.

In operation 425, the FEMS network construction apparatus 110 may acquire configuration information of the FEMS network 150 by operating the FEMS network 150 for a predetermined period of time.

In operation 430, the FEMS network construction apparatus 110 may obtain the first metric 310 based on configuration information of the FEMS network 150. For example, the FEMS network construction apparatus 110 may calculate the first metric 310 for all repeaters 180 and all communication nodes 170.

In operation 435, the FEMS network construction apparatus 110 may detect a communication shaded area on the FEMS network 150 based on the first metric 310. For example, the FEMS network construction apparatus 110 may identify whether the first metric 310 is less than the threshold 350 for all the repeaters 180 and all the communication nodes 170. The communication shaded area may include an area (an area where the repeater 180 or the communication node 170 is positioned) where the first metric 310 is less than the threshold 350. When the first metric 310 is less than the threshold 350 for any one of all the repeaters 180 and all the communication nodes 170, the FEMS network construction apparatus 110 may perform operation 440. When the first metric 310 is greater than the threshold 350 for all the repeaters 180 and all the communication nodes 170, the FEMS network construction apparatus 110 may perform operation 450.

When the communication shaded area is detected, the FEMS network construction apparatus 110 may add a repeater 180 in operation 440. The repeater 180 may be added to solve the communication shaded area. For example, the FEMS network construction apparatus 110 may additionally arrange the repeater 180 in an area where the communication node 170, for which the first metric 310 is less than the threshold 350, is positioned.

In operation 445, the FEMS network construction apparatus 110 may update the total number of repeaters by reflecting the number of repeaters 180 added. The FEMS network construction apparatus 110 may perform operation 425 based on the updated number of repeaters. Accordingly, the FEMS network construction apparatus 110 may solve (or remove) the communication shaded area. The FEMS network construction apparatus 110 may arrange the repeaters 180 to have the first metric 310 greater than the threshold 350 for all the repeaters 180 and all the communication nodes 170.

In operation 450, the FEMS network construction apparatus 110 may obtain the second metric 330 based on the configuration information of the FEMS network 150. For example, the FEMS network construction apparatus 110 may calculate the second metric 330 for all the repeaters 180 and all the communication nodes 170.

In operation 455, the FEMS network construction apparatus 110 may remove an unnecessary repeater 180 on the FEMS network 150 based on the second metric 330. The FEMS network construction apparatus 110 may identify whether the second metric 330 is less than the threshold 370 for all the repeaters 180 and all the communication nodes 170. For example, a repeater 180 for which the second metric 330 is less than the threshold 370 may be a repeater 180 that does not satisfy the utilization rate on the FEMS network 150. That is, even when the repeater 180 is removed, the effect on the performance of the FEMS network 150 may be insignificant. When the second metric 330 is less than the threshold 370 for any one of all the repeaters 180 and all the communication nodes 170, the FEMS network construction apparatus 110 may perform operation 460. When the second metric 330 is greater than the threshold 370 for all the repeaters 180 and all the communication nodes 170, the FEMS network construction apparatus 110 may perform operation 470.

In operation 460, the FEMS network construction apparatus 110 may remove an unnecessary repeater 180 in response to the identification that the second metric 330 is less than the threshold 370.

In operation 465, the FEMS network construction apparatus 110 may update the total number of repeaters by reflecting the number of repeaters reduced. The FEMS network construction apparatus 110 may perform operation 425 based on the total number of repeaters. Accordingly, the FEMS network construction apparatus 110 may remove an unnecessary repeater. The FEMS network construction apparatus 110 may arrange the repeaters 180 to have the second metric 310 greater than the threshold 370 for all the repeaters 180 and all the communication nodes 170.

When distribution of repeaters (the location of repeaters and the number of repeaters) is not optimized for all processes (e.g., energy management level) to be managed by the FEMS 130, in operation 470, the FEMS network construction apparatus 110 may perform operations 405 to 465. For example, when the distribution of repeaters is optimized for a utility process, the FEMS network construction apparatus 110 may perform operations 405 to 465 for a step process in which the distribution of repeaters is not optimized. Accordingly, the FEMS network construction apparatus 110 may optimize the distribution of repeaters for all processes to be managed by the FEMS 130.

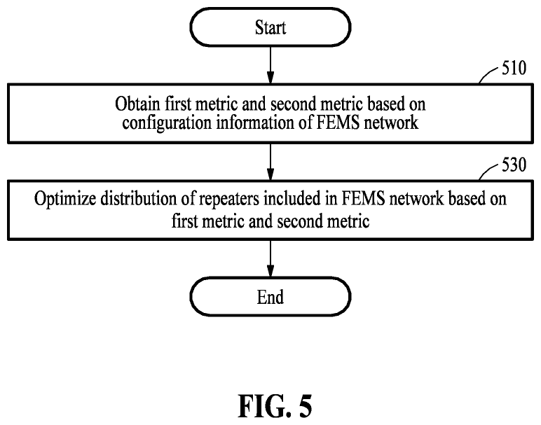

FIG. 5 is a flowchart illustrating another example of a method of constructing an FEMS network, according to an embodiment.

Referring to FIG. 5, operations 510 and 530 may be performed sequentially, but embodiments are not limited thereto. For example, two or more operations may be performed in parallel. Operations 510 to 530 may be substantially the same as the operations of the FEMS network construction apparatus 110 of FIG. 1 described with reference to FIGS. 1 to 4. Accordingly, a detailed description thereof is omitted.

In operation 510, the FEMS network construction apparatus 110 may obtain the first metric 310 and the second metric 330 based on the configuration of the FEMS network 150. The FEMS network 150 may provide a wireless communication method for communication between the communication node 170, the repeater 180, and the gateway 190. The wireless communication method may have a function of identifying a transmission error of a signal transmitted from the communication node 170 in the gateway 190. The wireless communication method may have a function of identifying a communication path of a signal transmitted from the communication node 170.

In operation 530, the FEMS network construction apparatus 110 may optimize the distribution of the repeaters 180 included in the FEMS network 150 based on the first metric 310 and the second metric 330. The FEMS network construction apparatus 110 may detect a communication shaded area on the FEMS network 150 based on the first metric 310. The FEMS network construction apparatus 110 may remove an unnecessary repeater on the FEMS network 150 based on the second metric 330.

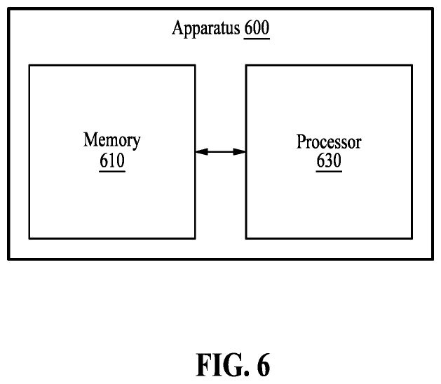

FIG. 6 illustrates an example of an apparatus according to an embodiment.

Referring to FIG. 6, an apparatus 600 may include a memory 610 and a processor 630. The apparatus 600 may include the FEMS network construction apparatus 110 of FIG. 1.

The memory 610 may store instructions (or programs) executable by the processor 630. For example, the instructions may include instructions for performing an operation of the processor 630 and/or an operation of each component of the processor 630.

The memory 610 may be implemented as a volatile memory device or a non-volatile memory device.

The volatile memory device may be implemented as dynamic random-access memory (DRAM), static random-access memory (SRAM), thyristor RAM (T-RAM), a zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, or insulator resistance change memory.

The processor 630 may process data stored in the memory 610. The processor 630 may execute computer-readable code (e.g., software) stored in the memory 610 and instructions triggered by the processor 630.

The processor 630 may be a hardware-implemented data processing device having a circuit that is physically structured to execute desired operations. For example, the desired operations may include code or instructions in a program.

For example, the hardware-implemented data processing device may include, for example, a microprocessor, a central processing unit (CPU), a processor core, a multi-core processor, a multiprocessor, an application-specific integrated circuit (ASIC), and a field programmable gate array (FPGA).

The FEMS network construction apparatus 110 of FIG. 1 may be stored in the memory 610 and executed by the processor 630 or embedded in the processor 630. The processor 630 may perform substantially the same operations as the operations of the FEMS network construction apparatus 110 of FIG. 1 with reference to FIGS. 1 to 5. Accordingly, a further description thereof is omitted herein.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller, an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular; however, one of ordinary skill in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc-read only memory (CD-ROM) and digital video discs (DVDs); magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

The above-described hardware devices may be configured to act as one or more software modules in order to perform the operations of the above-described embodiments, or vice versa.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A method of constructing a factory energy management system (FEMS) network, the method comprising:
obtaining a first metric and a second metric based on configuration information of the FEMS network; and
optimizing distribution of repeaters included in the FEMS network based on the first metric and the second metric,
wherein the first metric is related to whether a signal sent by a communication node is transmitted normally,
wherein the second metric is related to whether a specific repeater is included in a communication path through which the signal is transmitted.

2. The method of claim 1, wherein the FEMS network provides a wireless communication method having a function of identifying a transmission error of the signal transmitted from the communication node and a function of identifying the communication path of the signal.

3. The method of claim 2, wherein the optimizing of the distribution of the repeaters comprises:
detecting a communication shaded area on the FEMS network based on the first metric; and
adding a repeater to solve the communication shaded area when the communication shaded area is detected.

4. The method of claim 3, wherein the detecting of the communication shaded area comprises:
identifying whether the first metric is less than a threshold related to a probability that the signal is transmitted normally; and
detecting the communication shaded area in response to identifying that the first metric is less than the threshold.

5. The method of claim 2, wherein the optimizing of the distribution of the repeaters comprises removing an unnecessary repeater from the FEMS network based on the second metric.

6. The method of claim 5, wherein the removing of the unnecessary repeater comprises:
identifying whether the second metric is less than a threshold related to a probability that the specific repeater is included in the communication path; and
removing the unnecessary repeater in response to identifying that the second metric is less than the threshold.

7. The method of claim 1, wherein the obtaining of the first metric and the second metric and the optimizing of the distribution of repeaters are performed for all processes to be managed by the FEMS.

8. An apparatus for constructing a factory energy management system (FEMS) network, the apparatus comprising:
a memory configured to store one or more instructions; and
a processor configured to execute the instructions,
wherein the processor is configured to perform a plurality of operations when the instructions are executed,
wherein the plurality of operations comprises:
obtaining a first metric and a second metric based on configuration information of the FEMS network; and
optimizing distribution of repeaters included in the FEMS network based on the first metric and the second metric,
wherein the first metric is related to whether a signal from a communication node is transmitted normally, and
wherein the second metric is related to whether a specific repeater is included in a communication path through which the signal is transmitted.

9. The apparatus of claim 8, wherein the FEMS network provides a wireless communication method having a function of identifying a transmission error of the signal transmitted from the communication node and a function of identifying the communication path of the signal.

10. The apparatus of claim 9, wherein the optimizing of the distribution of the repeaters comprises:
detecting a communication shaded area on the FEMS network based on the first metric; and
adding a repeater to solve the communication shaded area when the communication shaded area is detected.

11. The apparatus of claim 10, wherein the detecting of the communication shaded area comprises:
identifying whether the first metric is less than a threshold related to a probability that the signal is transmitted normally; and
detecting the communication shaded area in response to identifying that the first metric is less than the threshold.

12. The apparatus of claim 9, wherein the optimizing of the distribution of the repeaters comprises removing an unnecessary repeater from the FEMS network based on the second metric.

13. The apparatus of claim 12, wherein the removing of the unnecessary repeater comprises:
identifying whether the second metric is less than a threshold related to a probability that the specific repeater is included in the communication path; and
removing the unnecessary repeater in response to identifying that the second metric is less than the threshold.

14. The apparatus of claim 8, wherein the plurality of operations is performed for all processes to be managed by the FEMS.
